(19) United States
(12) Patent Application Publication
(10) Pub. No.: US 2018/0270233 A1
(43) Pub. Date: Sep. 20, 2018

(54) INFORMATION TERMINAL, INFORMATION PROCESSING APPARATUS, INFORMATION PROCESSING SYSTEM, AND INFORMATION PROCESSING METHOD

(71) Applicants: Takeshi Homma, Kanagawa (JP); Takeshi Horiuchi, Tokyo (JP); Takafumi Takeda, Tokyo (JP)

(72) Inventors: Takeshi Homma, Kanagawa (JP); Takeshi Horiuchi, Tokyo (JP); Takafumi Takeda, Tokyo (JP)

(21) Appl. No.: 15/915,097

(22) Filed: Mar. 8, 2018

(30) Foreign Application Priority Data
Mar. 17, 2017 (JP) 2017-053237

(51) Int. Cl. H04L 29/06

(52) U.S. Cl. CPC H04L 63/0876

(57) ABSTRACT

Example embodiments of the present invention include an information terminal comprising circuitry to: read, from a medium possessed by a user, first authentication information of the user; transmit an authentication request including the read first authentication information of the user to a first information processing apparatus that manages information regarding the user; receive, from the first information processing apparatus in response to the authentication request, second authentication information associated with the first authentication information, the second authentication information to be used for allowing the user to log in to a second information processing apparatus that resides on a network different from a network where the first information processing apparatus resides; and transmit the received second authentication information to the second information processing apparatus to request the second information processing apparatus for a service corresponding to the user.

### CROSS-REFERENCE TO RELATED APPLICATIONS

This patent application is based on and claims priority pursuant to 35 U.S.C. § 119(a) to Japanese Patent Application No. 2017-053237, filed on Mar. 17, 2017, in the Japan Patent Office, the entire disclosure of which is hereby incorporated by reference herein.

### BACKGROUND

### Technical Field

The present invention relates to an information terminal, an information processing apparatus, an information processing system, and an information processing method.

### Description of the Related Art

In an office environment, for example, a management server connected to an internal network, such as a local area network (LAN), is provided to authenticate a user to use a device in the office. Further, a management server connected to an external network, such as the Internet, is provided to authenticate a terminal, or a user operating such terminal. With this configuration, login operations differ between the case where the management server on the internal network authenticates the user, and the case where the management server on the external network authenticates the user, resulting in decrease in operability for the user.

### SUMMARY

Example embodiments of the present invention include an information terminal comprising circuitry to: read, from a medium possessed by a user, first authentication information of the user; transmit an authentication request including the read first authentication information of the user to a first information processing apparatus that manages information regarding the user; receive, from the first information processing apparatus in response to the authentication request, second authentication information associated with the first authentication information, the second authentication information to be used for allowing the user to log in to a second information processing apparatus that resides on a network different from a network where the first information processing apparatus resides; and transmit the received second authentication information to the second information processing apparatus to request the second information processing apparatus for a service corresponding to the user.

Example embodiments of the present invention include An information processing apparatus comprising circuitry to: receive, from an information terminal, first authentication information of a user read from a medium possessed by the user; perform authentication of the user based on the received first authentication information; and based on a determination that authentication of the user is successful, transmit, to the information terminal, second authentication information associated with the first authentication information, the second authentication information to be used for allowing the user to log in to other information processing apparatus, the other information processing apparatus residing on a network different from a network where the information processing apparatus resides and providing to the information terminal a service corresponding to the user.

Example embodiments of the present invention include An information processing apparatus comprising circuitry to: receive, from an information terminal, authentication information of the user; determine whether the authentication information of the user is second authentication information associated with first authentication information, which is transmitted from other information processing apparatus that has authenticated the user at the information terminal using the first authentication information; perform authentication of the user based on the authentication information of the user, based on a determination that the authentication information of the user is second authentication information; and provide a service corresponding to the user to the information terminal based on a determination that the authentication of the user is successful.

Example embodiments of the present invention include an information processing system including any one of the above-described information terminal and the information processing apparatuses.

Example embodiments of the present invention include a method performed by any one of the above-described information terminal and the information processing apparatuses.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example overall configuration of an information processing system according to an embodiment;

FIG. 2 is a block diagram illustrating an example hardware configuration of a wide area network (WAN) device according to an embodiment;

FIG. 3 is a block diagram illustrating an example hardware configuration of a WAN device management apparatus and a LAN device management apparatus according to an embodiment;

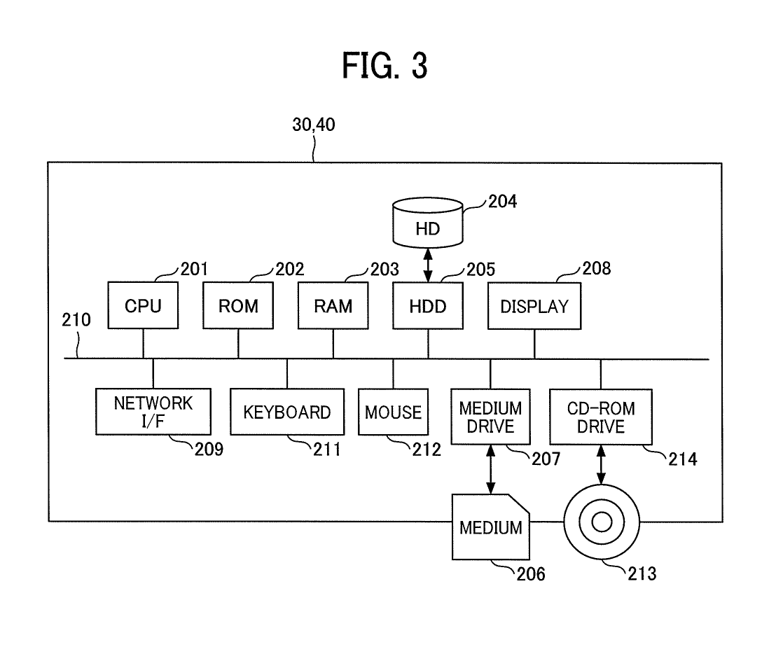

FIG. 4 is a functional block diagram illustrating an example functional configuration of the information processing system according to an embodiment;

FIG. 5 is a sequence diagram illustrating an example process for authenticating a LAN device;

FIG. 6 is a diagram illustrating an example of LAN device authentication information;

FIG. 7 is a sequence diagram illustrating an example process for authenticating the WAN device;

FIG. 8 is a diagram illustrating an example of WAN device authentication information; and

FIG. 9 is a flowchart illustrating an example process for authenticating a user of the WAN device by the WAN device management apparatus.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, an embodiment of the present invention will be described with reference to the attached drawings.

Example Overall Configuration

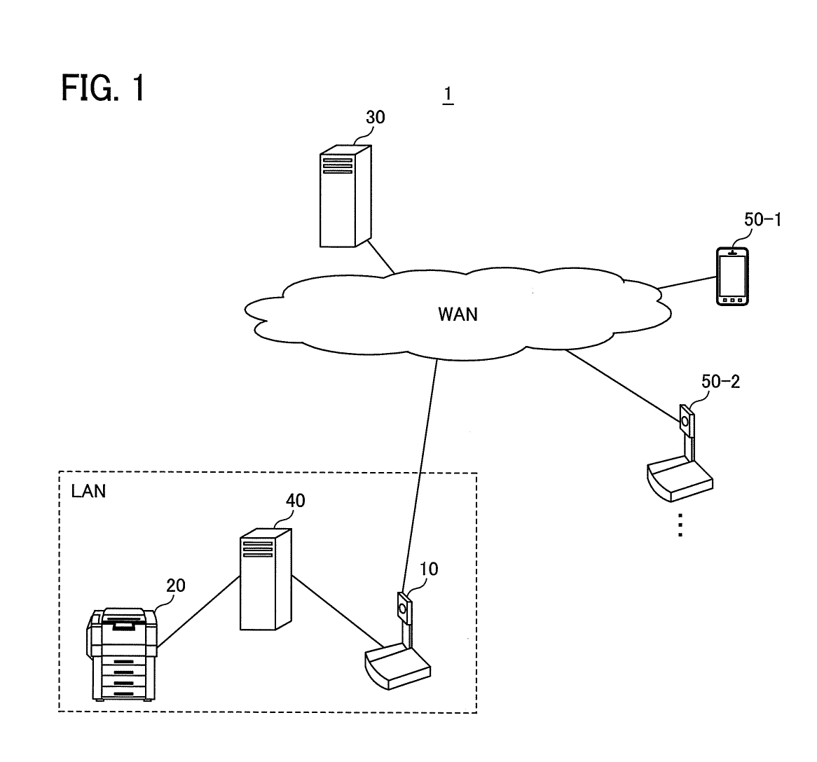

FIG. 1 is a diagram illustrating an example overall configuration of an information processing system 1 according to an embodiment. The information processing system 1 includes a WAN device 10, a LAN device 20, a WAN device management apparatus 30, a LAN device management apparatus 40, and WAN devices 50-1, 50-2, . . . . The number of each of these devices and apparatuses may be more than one.

The WAN device 10 and the LAN device management apparatus 40 are connected to each other and the LAN device 20 and the LAN device management apparatus 40 are connected to each another via a LAN, such as a wireless LAN.

The WAN device 10, the WAN devices 50-1, 50-2, . . . , and the WAN device management apparatus 30 are connected to one another via a WAN, which is an external network, such as the Internet (cloud).

The WAN device 10 and the WAN devices 50-1, 50-2, . . . are information terminals that are managed by the WAN device management apparatus 30 via the WAN and are, for example, dedicated terminals, such as videoconference terminals, electronic whiteboards, or digital signage displays, or terminals, such as tablets, smartphones, or personal computers (PCs). The WAN device 10 may be placed in, for example, a meeting room and shared by a plurality of users.

The WAN device 10 may have, for example, a communication function for, for example, a videoconference with the WAN devices 50-1, 50-2, . . . via the WAN. In the information processing system 1, the types of terminals and the numbers of terminals are not specifically limited.

The LAN device 20 is an information terminal managed by the LAN device management apparatus 40 via the LAN and is, for example, a multifunctional peripheral (MFP).

The WAN device management apparatus 30 is, for example, an information processing apparatus that is used as a server. The WAN device management apparatus 30 manages the WAN device 10 and, for example, performs login authentication for the WAN device 10 via the WAN. The WAN device management apparatus 30 authenticates, on the basis of an account ID and a password, login from the WAN device 10 and from the WAN devices 50-1, 50-2, . . . . The WAN device management apparatus 30 authenticates login from the WAN device 10 using the LAN device management apparatus 40. When the login authentication is successful, the WAN device management apparatus 30 provides a predetermined service to the WAN device 10 and to the WAN devices 50-1, 50-2, . . . . For example, the WAN device management apparatus 30 displays an address book that corresponds to the logged-in user to allow the user to perform transmission and reception to one or more counterparts selected from the address book in a videoconference.

The WAN device management apparatus 30 resides on, for example, the cloud and operated by an operator that performs maintenance and so on of the WAN device 10.

The LAN device management apparatus 40 is, for example, an information processing apparatus that is used as a server. The LAN device management apparatus 40 manages the LAN device 20 and, for example, performs login authentication for the LAN device 20 via the LAN.

The LAN device management apparatus 40 performs user authentication for the WAN device 10. If the authentication is successful, the LAN device management apparatus 40 communicates to the WAN device 10 a password for logging in to the WAN device management apparatus 30 in response to the user authentication to allow the user to log in to the WAN device management apparatus 30. Accordingly, the user can perform an operation similar to a login operation that is performed at the LAN device 20, namely, an operation of, for example, putting his or her employee ID card over a card reader, to log in to the WAN device management apparatus 30 from the WAN device 10.

The LAN device management apparatus 40 resides on the LAN of, for example, an office and operated by the administrator of the office. The LAN device management apparatus 40 may provide the user authentication function using, for example, an employee ID card to not only the WAN device management apparatus 30 but also a server connected to the LAN or to the WAN and providing other services.

Example Hardware Configurations

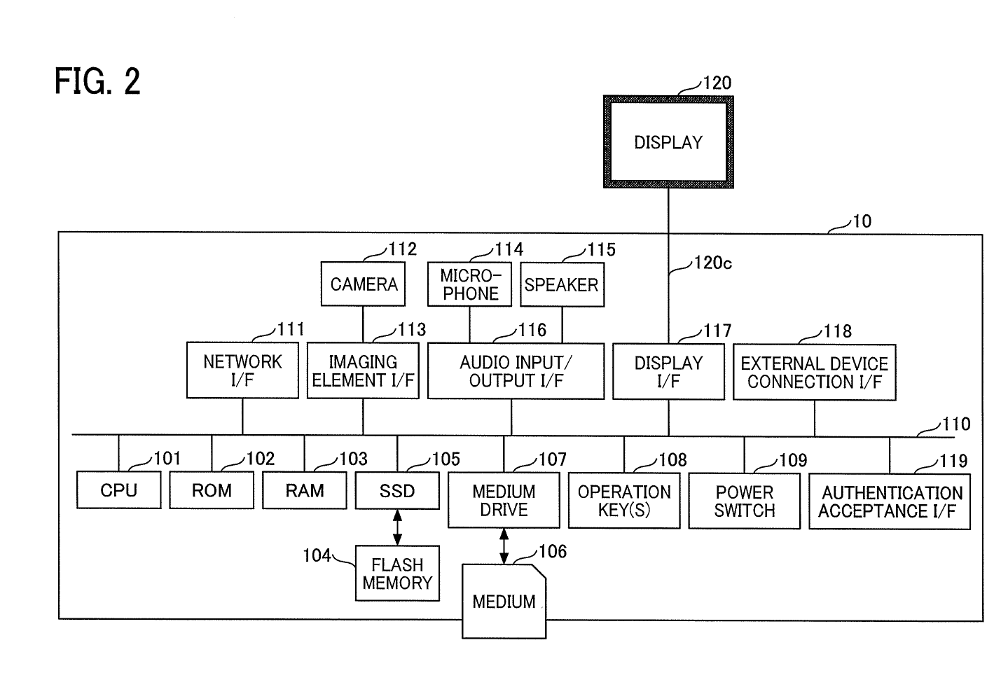

FIG. 2 is a block diagram illustrating an example hardware configuration of the WAN device 10 according to an embodiment. As illustrated, the WAN device 10 includes a central processing unit (CPU) 101, a read-only memory (ROM) 102, and a random access memory (RAM) 103. The WAN device 10 further includes a flash memory 104, a solid-state drive (SSD) 105, a medium drive 107, an operation key 108, and a power switch 109. The WAN device 10 further includes a network interface (I/F) 111, a camera 112, an imaging element I/F 113, a microphone 114, a speaker 115, an audio input/output OF 116, a display I/F 117, an external device connection I/F 118, and an authentication acceptance I/F 119. These hardware devices are connected to one another via a bus line 110.

The CPU 101 is an arithmetic device that performs operations to implement processing and data processing that are performed by the WAN device 10. Further, the CPU 101 is a control device that controls each hardware device. Accordingly, the CPU 101 controls overall operations of the WAN device 10.

The ROM 102, the RAM 103, the flash memory 104, and the SSD 105 are examples of memory devices. For example, the ROM 102 stores a program, such as an initial program loader (IPL), used to drive the CPU 101. The RAM 103 is an example of a main memory device and is used as, for example, a work area of the CPU 101. In the flash memory 104, the SSD 105 stores a terminal program and data, such as image data and audio data, in accordance with control by the CPU 101.

The medium drive 107 allows a medium 106, which is a recording medium, such as a flash memory or an optical disk, to be connected to the WAN device 10. The medium drive 107 reads/writes data from/to the medium 106.

An information processing program for implementing processing that is performed by the WAN device 10 is provided via, for example, the medium 106. When the medium 106 to which the information processing program is recorded is put into the medium drive 107, the information processing program is installed in the SSD 105 from the medium 106 via the medium drive 107. The information processing program need not be installed from the medium 106 and may be downloaded from another computer via a network.

The medium 106 is, for example, a portable recording medium, such as a compact disc read-only memory (CD-ROM), a digital versatile disk (DVD), or a universal serial bus (USB) memory. The medium 106 and any of the memory devices including the SSD 105 correspond to computer-readable recording media.

The operation key 108 is an example of an input device for receiving user operations. For example, the operation key 108 is used in a case of, for example, selecting a counterpart with which the WAN device 10 communicates.

The power switch 109 is used in a switching operation of turning ON and OFF the power of the WAN device 10.

The network I/F 111 is an interface for allowing the WAN device 10 to be connected to a network. For example, the network I/F 111 is used to transmit/receive data to/from an external apparatus via a communication network.

The camera 112 captures an image of a subject and generates image data. The camera 112 is controlled by the imaging element I/F 113. That is, the imaging element I/F 113 transmits image data generated by the camera 112 to an external apparatus via a communication network, for example.

The microphone 114 receives sound and generates audio data. The speaker 115 outputs sound based on audio data. The audio input/output I/F 116 controls the microphone 114 and the speaker 115 individually.

The display I/F 117 allows a display 120 to be connected via a cable 120c. The display 120 is an example of an output device that displays, for example, images and icons for operations. The cable 120c is, for example, a cable for analog RGB (VGA) signals, component video, High-Definition Multimedia Interface (HDMI) (registered trademark), or Digital Visual Interface (DVI). The external device connection I/F 118 controls communication with a USB memory and external devices (such as a camera, a speaker, and a microphone).

The authentication acceptance I/F 119 is an interface for accepting authentication. For example, the authentication acceptance I/F 119 is connected to, for example, a card reader and obtains user information recorded to a card, such as an employee ID card, read by the card reader. The authentication acceptance I/F 119 is implemented as, for example, a communication circuit that enables short-range wireless communication.

The WAN device management apparatus 30 includes a CPU 201, a ROM 202, a RAM 203, a hard disk (HD) 204, a hard disk drive (HDD) 205, a medium drive 207, a display 208, and a network I/F 209. The WAN device management apparatus 30 further includes a keyboard 211, a mouse 212, and a CD-ROM drive 214. These hardware devices are connected to one another via a bus line 210.

The CPU 201 is an arithmetic device that performs operations to implement processing and data processing that are performed by the WAN device management apparatus 30. Further, the CPU 201 is a control device that controls each hardware device. Accordingly, the CPU 201 controls overall operations of the WAN device management apparatus 30.

The ROM 202, the RAM 203, the HD 204, and the HDD 205 are examples of memory devices. For example, the ROM 202 stores a program, such as an IPL, used to drive the CPU 201. The RAM 203 is an example of a main memory device and is used as, for example, a work area of the CPU 201. In the HD 204, the HDD 205 stores predetermined data in accordance with control by the CPU 201.

The medium drive 207 allows a medium 206, which is a recording medium, such as a flash memory or an optical disk, to be connected to the WAN device management apparatus 30. The medium drive 207 reads/writes data from/to the medium 206.

An information processing program for implementing processing that is performed by the WAN device management apparatus 30 is provided via, for example, the medium 206. When the medium 206 to which the information processing program is recorded is put into the medium drive 207, the information processing program is installed in the HDD 205 from the medium 206 via the medium drive 207. The information processing program need not be installed from the medium 206 and may be downloaded from another computer via a network.

The medium 206 is, for example, a portable recording medium, such as a CD-ROM, a DVD, or a USB memory. The medium 206 and any of the memory devices including the HDD 205 correspond to computer-readable recording media.

The display 208 is an example of an output device that displays, for example, images and icons for operations.

The network I/F 209 is an interface for allowing the WAN device management apparatus 30 to be connected to a network. For example, the network IN 209 is used to transmit/receive data to/from an external apparatus via a communication network.

The keyboard 211 and the mouse 212 are examples of input devices for receiving user operations.

The CD-ROM drive 214 allows a medium 213, which is a recording medium, such as a CD-ROM, to be connected to the WAN device management apparatus 30. The CD-ROM drive 214 reads/writes data from/to the medium 213.

Example Functional Configuration

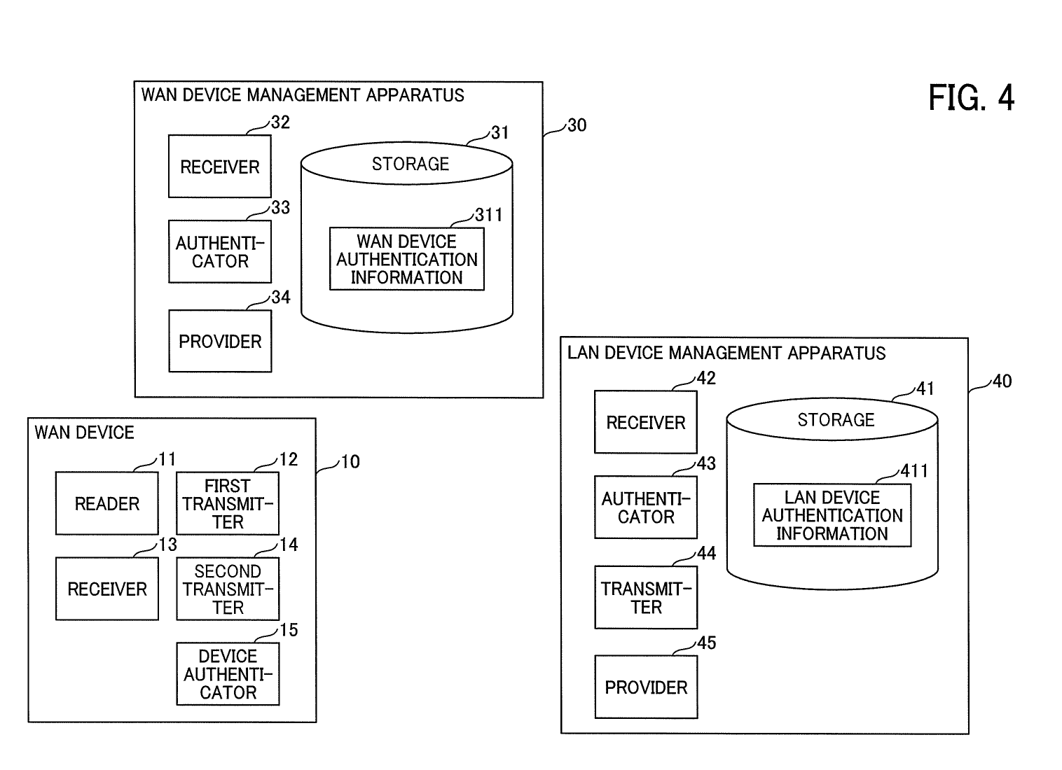

Now, a functional configuration of each of the apparatuses and device included in the information processing system 1 according to an embodiment is described with reference to FIG. 4. FIG. 4 is a functional block diagram illustrating an example functional configuration of the information processing system 1 according to an embodiment.

WAN Device

The WAN device 10 includes a reader 11, a first transmitter 12, a receiver 13, a second transmitter 14, and a device authenticator 15. These units are implemented as processing that one or more programs installed on the WAN device 10 cause the CPU 101 of the WAN device 10 to perform.

The reader 11 reads individual authentication information (an example of “first authentication information”) of a user from, for example, an employee ID card (an example of a “predetermined medium”) possessed by the user.

The first transmitter 12 transmits an authentication request including the individual authentication information read by the reader 11 to the LAN device management apparatus 40.

The receiver 13 receives a second password (an example of “second authentication information”) from the LAN device management apparatus 40 in response to the authentication request transmitted by the first transmitter 12. The second password is data corresponding to the individual authentication information described above and data for allowing the user to log in to the WAN device management apparatus 30.

The second transmitter 14 transmits the second password received by the receiver 13 to the WAN device management apparatus 30.

The device authenticator 15 uses identification information of the WAN device 10 to have the WAN device 10 subjected to device authentication by the WAN device management apparatus 30.

WAN Device Management Apparatus

The WAN device management apparatus 30 includes a receiver 32, an authenticator 33, and a provider 34. These units are implemented as processing that one or more programs installed on the WAN device management apparatus 30 cause the CPU 201 of the WAN device management apparatus 30 to perform.

The WAN device management apparatus 30 further includes a storage 31. The storage 31 is implemented by using, for example, an auxiliary memory device, such as the HDD 205. The storage 31 stores WAN device authentication information 311. Data included in the WAN device authentication information 311 will be described below.

The receiver 32 receives from the WAN device 10 a second password indicating that the LAN device management apparatus 40 successfully authenticates a user of the WAN device 10.

The authenticator 33 authenticates the user of the WAN device 10 on the basis of the second password received by the receiver 32.

In a case where the authentication by the authenticator 33 is successful, the provider 34 provides a predetermined service corresponding to the user of the WAN device 10 to the WAN device 10.

LAN Device Management Apparatus

The LAN device management apparatus 40 includes a receiver 42, an authenticator 43, a transmitter 44, and a provider 45. These units are implemented as processing that one or more programs installed on the LAN device management apparatus 40 cause the CPU of the LAN device management apparatus 40 to perform.

The LAN device management apparatus 40 further includes a storage 41. The storage 41 is implemented by using, for example, an auxiliary memory device, such as an HDD. The storage 41 stores LAN device authentication information 411. Data included in the LAN device authentication information 411 will be described below.

The receiver 42 receives individual authentication information read from, for example, an employee ID card possessed by a user from the WAN device 10 or from the LAN device 20.

The authenticator 43 authenticates the user of the WAN device 10 or the user of the LAN device 20 on the basis of the individual authentication information received by the receiver 42.

In a case where the authenticator 43 successfully authenticates the user of the WAN device 10, the transmitter 44 transmits to the WAN device 10 a second password corresponding to the individual authentication information described above. In a case where the authenticator 43 successfully authenticates the user of the LAN device 20, the transmitter 44 transmits to the LAN device 20 a response indicating successful login.

In the case where the authenticator 43 successfully authenticates the user of the LAN device 20, the provider 45 provides a predetermined service corresponding to the user to the LAN device 20. For example, the provider 45 manages a usage history regarding, for example, printing by the LAN device 20 in association with the user.

Processing

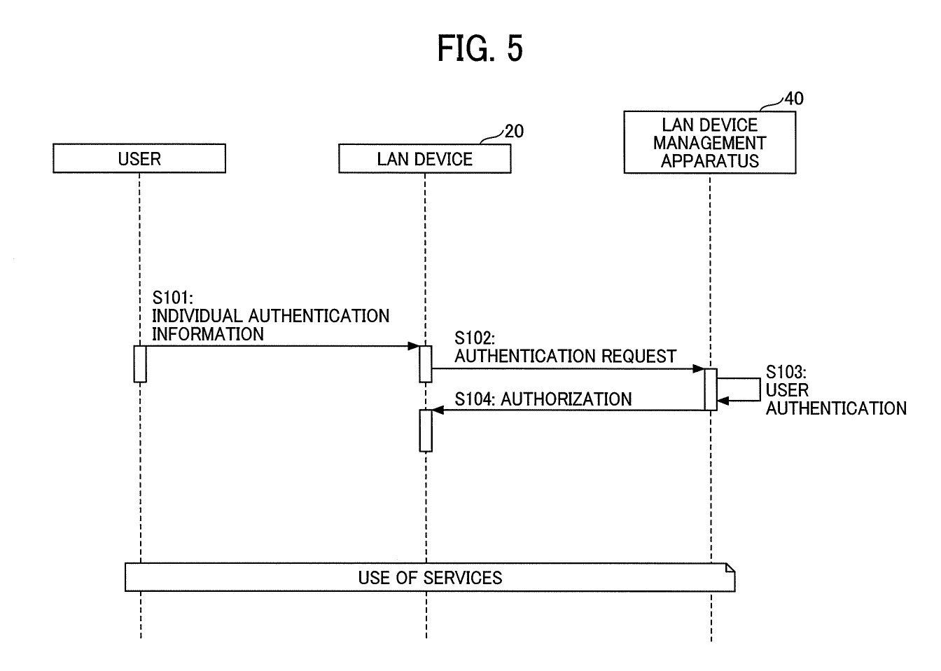

Now, a process for authenticating the LAN device 20 of the information processing system 1 according to an embodiment is described with reference to FIG. 5. FIG. 5 is a sequence diagram illustrating an example process for authenticating the LAN device 20.

In step S101, according to a user operation of bringing a card closer to a card reader, the LAN device 20 obtains individual authentication information stored on the card via the card reader.

The card storing individual authentication information is, for example, an ID card, such as an employee ID card, a mobile terminal of the user, or a Near Field radio Communication (NFC) card. The card reader reads the individual authentication information via, for example, contactless communication using NFC or contact communication using an IC card reader.

Subsequently, the LAN device 20 transmits an authentication request including the obtained individual authentication information to the LAN device management apparatus 40 (step S102).

Subsequently, the authenticator 43 of the LAN device management apparatus 40 authenticates the user on the basis of the individual authentication information received by the receiver 42 and the LAN device authentication information 411 (step S103).

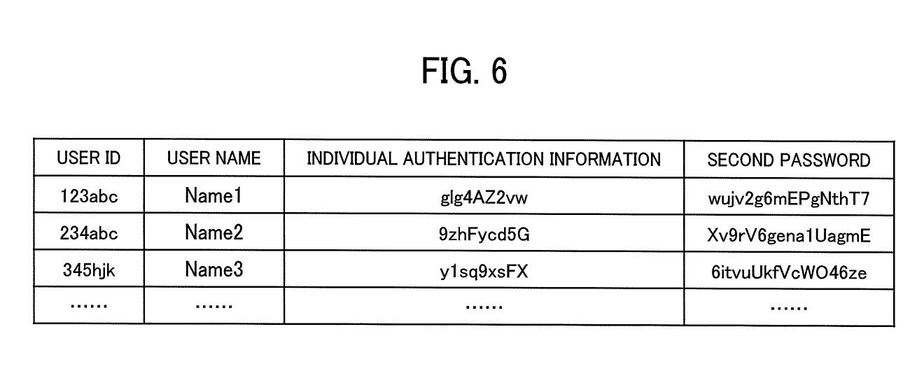

FIG. 6 is a diagram illustrating an example of the LAN device authentication information 411. The LAN device authentication information 411 includes a user name, individual authentication information, a second password, and so on in association with each user ID. The user ID is identification information of each user who is, for example, an employee. The user name is the name of the user. The individual authentication information is information stored on, for example, an employee ID card possessed by the user and used to authenticate the user. The second password is data for user authentication managed by both the LAN device management apparatus 40 and the WAN device management apparatus 30 in association with the user.

The LAN device authentication information 411 is registered in advance by an operation performed by, for example, the administrator.

In step S103, the authenticator 43 of the LAN device management apparatus 40 compares the received individual authentication information with the pieces of individual authentication information included in the LAN device authentication information 411 illustrated in FIG. 6 and determines that the user authentication is successful if the LAN device authentication information 411 includes a piece of individual authentication information that matches the received individual authentication information.

Subsequently, the transmitter 44 of the LAN device management apparatus 40 transmits the result of authentication to the LAN device 20 (step S104).

Accordingly, if a user is successfully authenticated, the user can use services using the LAN device 20. For example, the provider 45 of the LAN device management apparatus 40 manages the usage history of the LAN device 20 in association with the user and provides services, such as management of the number of printed copies.

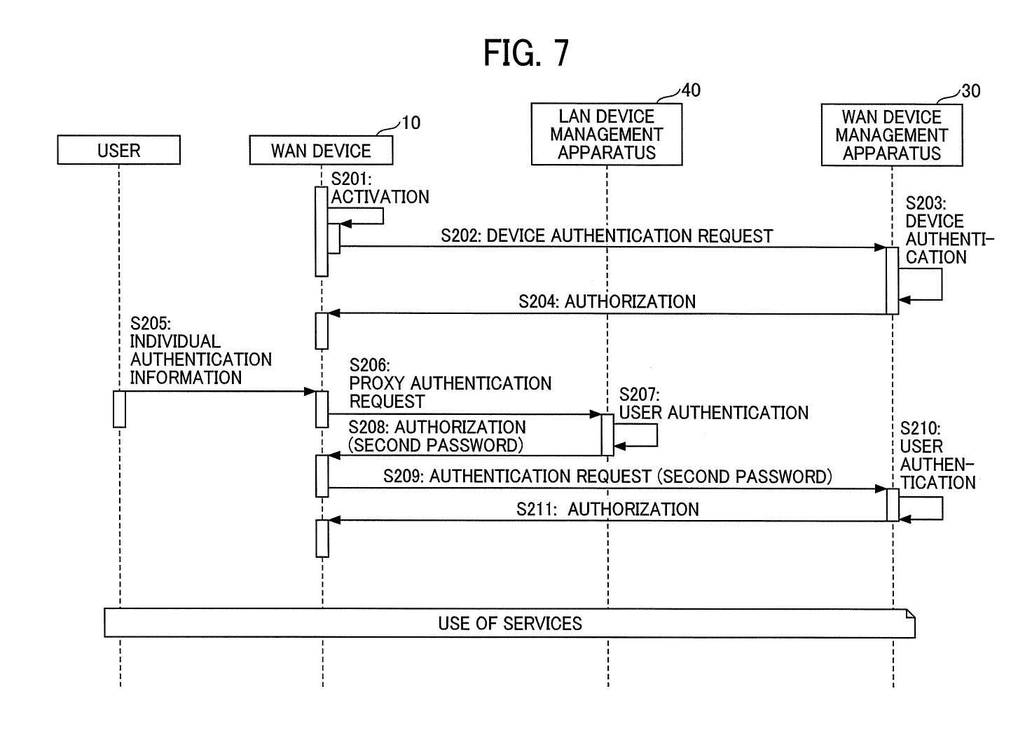

Now, a process for authenticating the WAN device 10 of the information processing system 1 according to an embodiment is described with reference to FIG. 7. FIG. 7 is a sequence diagram illustrating an example process for authenticating the WAN device 10, performed by the information processing system 1 according to an embodiment.

In step S201, the WAN device 10 is activated in response to a predetermined operation of, for example, turning on the power performed by a user.

Subsequently, the device authenticator 15 of the WAN device 10 transmits a device authentication request to the WAN device management apparatus 30 (step S202). The process in step S202 need not be performed upon activation and may be performed upon accepting, for example, a predetermined operation performed by the user.

Subsequently, the authenticator 33 of the WAN device management apparatus 30 performs device authentication for the WAN device 10 (step S203). Here, for example, the authenticator 33 of the WAN device management apparatus 30 obtains from the WAN device 10 a client certificate installed in advance on the WAN device 10 and performs device authentication on the basis of identification information of the WAN device 10, such as Common Name, included in the client certificate.

Subsequently, the authenticator 33 of the WAN device management apparatus 30 transmits the result of authentication to the WAN device 10 (step S204). In a case where the device authentication is successful, the WAN device management apparatus 30 may establish, with the WAN device 10, a secure communication session encrypted by using, for example, Transport Layer Security (TLS). The communication session may be a session of the transport layer of, for example, TLS or may be a session based on the protocol of, for example, the application layer of, for example, Session Initiation Protocol (SIP) or Extensible Messaging and Presence Protocol (XMPP) using TLS.

In response to a user operation of bringing a card close to a card reader, the reader 11 of the WAN device 10 obtains individual authentication information stored on the card of the user (step S205). The process in step S205 is similar to the process in step S101 in FIG. 5 described above.

Subsequently, the first transmitter 12 of the WAN device 10 transmits a proxy authentication request including the obtained individual authentication information to the LAN device management apparatus 40 (step S206). Subsequently, the authenticator 43 of the LAN device management apparatus 40 performs proxy authentication of the user on the basis of the individual authentication information received by the receiver 42 and the LAN device authentication information 411 (step S207).

In step S207, the authenticator 43 of the LAN device management apparatus 40 compares the received individual authentication information with the pieces of individual authentication information included in the LAN device authentication information 411 illustrated in FIG. 6 and determines that the user authentication is successful if the LAN device authentication information 411 includes a piece of individual authentication information that matches the received individual authentication information.

Subsequently, the transmitter 44 of the LAN device management apparatus 40 transmits the result of proxy authentication to the WAN device 10 (step S208). In a case where the proxy authentication is successful, the transmitter 44 of the LAN device management apparatus 40 includes the second password of the user included in the LAN device authentication information 411 illustrated in FIG. 6 in the result of proxy authentication and transmits the result of proxy authentication to the WAN device 10. In a case where the proxy authentication fails, the transmitter 44 of the LAN device management apparatus 40 sends a notification that the proxy authentication fails to the WAN device 10, and ends the process.

Subsequently, in the case where the proxy authentication is successful, the second transmitter 14 of the WAN device 10 transmits an authentication request including the second password obtained from the LAN device management apparatus 40 to the WAN device management apparatus 30 (step S209). Here, the second transmitter 14 of the WAN device 10 may use the session using TLS established between the WAN device 10 and the WAN device management apparatus 30 in step S204 upon successful device authentication to transmit the second password. The second transmitter 14 of the WAN device 10 may obtain a token that is issued by the WAN device management apparatus 30 in step S204 upon successful device authentication and transmit the second password using the token. The token is, for example, one-time password information, and the WAN device management apparatus 30 determines whether the WAN device 10 has been subjected to device authentication on the basis of the token.

Accordingly, the authenticator 33 of the WAN device management apparatus 30 can perform user authentication using the second password under the assumption that the device authentication of the WAN device 10 is successful.

Subsequently, the authenticator 33 of the WAN device management apparatus 30 performs user authentication on the basis of the received second password and the WAN device authentication information 311 (step S210).

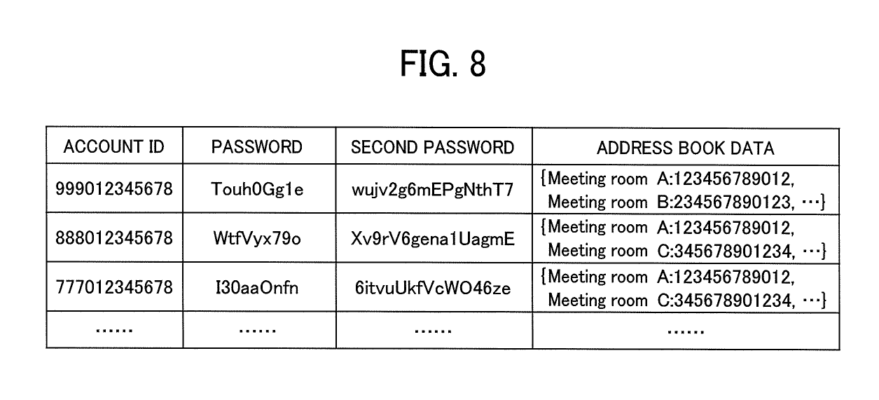

FIG. 8 is a diagram illustrating an example of the WAN device authentication information 311. The WAN device authentication information 311 includes a password (first password), a second password, address book data, and so on in association with each account ID. The account ID is the account ID (user ID) of each user who is allowed to use the WAN device 10. The first password is a password for the user to log in to the WAN device management apparatus 30 using the WAN device 10. The address book data is data of an address book of the user corresponding to the account ID. The address book includes information, such as the names, communication addresses, and so on of the other WAN devices 50-1, 50-2, . . . that are registered in accordance with an operation and so on performed by the user and are counterparts in a videoconference. The WAN device authentication information 311 is registered in advance by an operation performed by, for example, the administrator.

In step S210, the authenticator 33 of the WAN device management apparatus 30 compares the received second password with the second passwords included in the WAN device authentication information 311 illustrated in FIG. 8 and determines that the user authentication is successful if the WAN device authentication information 311 includes a second password that matches the received second password.

Subsequently, the provider 34 of the WAN device management apparatus 30 transmits the result of authentication to the WAN device 10 (step S211).

In a case where the user authentication is successful, the provider 34 of the WAN device management apparatus 30 transmits the address book data and so on that is associated with the second password to the WAN device 10. Accordingly, the user can use services using the WAN device 10, such as origination of a videoconference call using the address book.

Modification

In the example described above, the description has been given under the assumption that the second passwords included in the LAN device authentication information 411 and in the WAN device authentication information 311 are set in advance by, for example, the administrator or a user. Alternatively, the second passwords may be one-time passwords. In this case, the LAN device management apparatus 40 and the WAN device management apparatus 30 store in advance, for example, random numbers for each user and a method for generating a second password and, when receiving a user authentication request from the WAN device 10, generates a second password on the basis of the random numbers of each user and, for example, the current time.

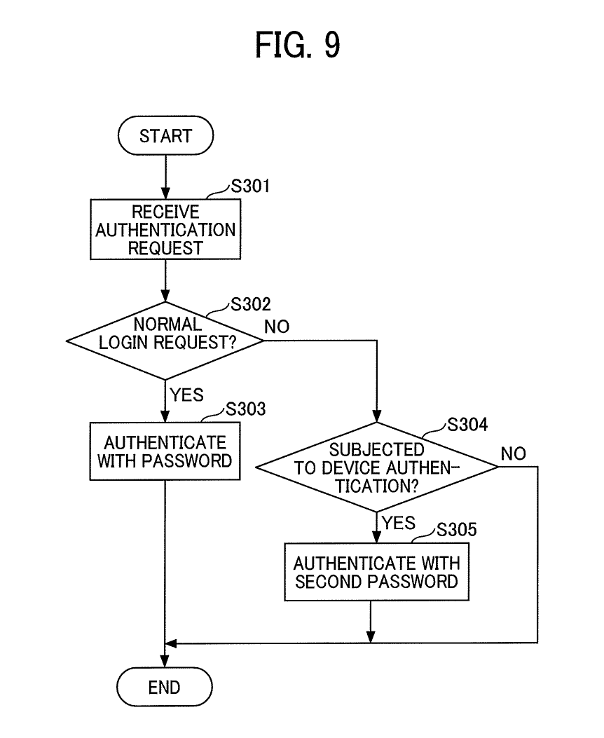

Now, a process for authenticating a user of the WAN device 10 by the WAN device management apparatus 30 according to an embodiment is described with reference to FIG. 9. FIG. 9 is a flowchart illustrating an example process for authenticating a user of the WAN device 10 by the WAN device management apparatus 30.

In step S301, the WAN device management apparatus 30 receives an authentication request from one of the WAN device 10 and the WAN devices 50-1, 50-2, . . . .

Subsequently, the WAN device management apparatus 30 determines whether the received authentication request is a normal login request (step S302). Here, the WAN device management apparatus 30 determines whether the received authentication request is a normal login request on the basis of, for example, data included in the received authentication request.

If the received authentication request is a normal login request (Yes in step S302), the WAN device management apparatus 30 performs user authentication on the basis of an account ID and a password included in the received authentication request and the WAN device authentication information 311 (step S303), and ends the process.

Here, the WAN device management apparatus 30 compares the account ID and the password included in the received authentication request with the combinations of the account IDs and passwords included in the WAN device authentication information 311 illustrated in FIG. 8 and determines that the user authentication is successful if the WAN device authentication information 311 includes a combination that matches the account ID and the password included in the received authentication request.

If the received authentication request is not a normal login request (No in step S302), the WAN device management apparatus 30 determines whether the one of the WAN device 10 and the WAN devices 50-1, 50-2, . . . that sends the authentication request has been subjected to device authentication in the process in step S203 described above (step S304).

If the device has not been subjected to device authentication (No in step S304), the WAN device management apparatus 30 ends the process. Accordingly, the user authentication fails.

If the device has been subjected to device authentication (Yes in step S304), the WAN device management apparatus 30 performs the process in step S210 described above. That is, the WAN device management apparatus 30 compares the received second password with the second passwords included in the WAN device authentication information 311 to perform user authentication (step S305), and ends the process.

As described above, in the information processing system 1 according to an embodiment, the WAN device 10 reads, from a medium, such as an employee ID card, possessed by a user, first authentication information of the user and is subjected to user authentication by the LAN device management apparatus 40 on the basis of the first authentication information. If the user authentication is successful, the WAN device 10 obtains a second password from the LAN device management apparatus 40 and transmits the second password to the WAN device management apparatus 30 to log in to the WAN device management apparatus 30.

Accordingly, for example, at the WAN device 10 connected to an external network, a user can perform an operation similar to an operation of, for example, putting his or her employee ID card over a card reader performed at the LAN device 20 connected to an internal network to log in to the WAN device management apparatus 30 on the external network. As a result, login operations by a user become more convenient.

Even in a case where, for example, the WAN device management apparatus 30 and the LAN device management apparatus 40 are connected to different networks and, for example, a widely available single sign-on capability is not usable or in a case where at least one of the WAN device management apparatus 30 and the LAN device management apparatus 40 does not support, for example, a single sign-on capability, a user can use a plurality of services including a videoconference and printing by an MFP by using a single user account.

In a case where a copied data of the LAN device authentication information 411 is simply stored on the WAN device management apparatus 30 and user authentication is performed on the basis of the data, if, for example, authentication data in the WAN device management apparatus 30 is compromised via the Internet, for example, authentication data stored on the WAN device management apparatus 30 and authentication data stored on the LAN device management apparatus 40 need to be rewritten or updated in order to prevent unauthorized use of other services of, for example, an MFP. Further, data of employee ID cards possessed by users needs to be rewritten, or employee ID cards and so on need to be, for example, updated, which is relatively troublesome.

According to this embodiment, even in the case where, for example, authentication data in the WAN device management apparatus 30 is compromised via the Internet, only second passwords stored on the WAN device management apparatus 30 and second passwords stored on the LAN device management apparatus 40 need to be changed. The WAN device management apparatus 30 performs user authentication on the basis of the combination of the second password and device authentication. Therefore, for example, in a case where the WAN device 10 is placed in, for example, a meeting room in a company and a malicious user is unable to operate the WAN device 10, the second passwords need not be changed.

The processes according to the embodiment of the present invention are performed by not only the apparatuses and devices described above. That is, in an embodiment of the present invention, the processes may be performed by an apparatus or a device other than the apparatuses and devices described above. Further, the processes may be performed in a redundant, distributed, or parallel manner or a combination thereof.

The embodiment of the present invention may be implemented as a program for causing a computer, which is, for example, an information terminal, an information processing apparatus, or an information processing system including one or more information processing apparatuses, to perform an information processing method.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An information terminal comprising circuitry,
the circuitry being configured to:
read, from a medium possessed by a user, first authentication information of the user;
transmit an authentication request including the first authentication information of the user to a first information processing apparatus that manages information regarding the user;
receive, from the first information processing apparatus in response to the authentication request, second authentication information associated with the first authentication information, the second authentication information to be used for allowing the user to log in to a second information processing apparatus that resides on a network different from a network where the first information processing apparatus resides; and
transmit the second authentication information to the second information processing apparatus to request the second information processing apparatus for a service corresponding to the user.

2. The information terminal according to claim 1,
wherein the circuity is configured to transmit identification information of the information terminal to the second information processing apparatus to request for device authentication of the information terminal, before transmitting the second authentication information to the second information processing apparatus.

3. The information terminal according to claim 2,
wherein the circuitry is configured to transmit the second authentication information to the second information processing apparatus, using one of: an encrypted communication session established between the information terminal and the second information processing apparatus in the device authentication; and a token issued from the second information processing apparatus in the device authentication.

4. The information terminal according to claim 1,
wherein the medium possessed by the user is at least one of an ID card, a mobile terminal, and a Near Field radio Communication card, possessed by the user.

5. An information processing system comprising:
the information terminal of claim 1, the circuitry being first circuitry; and
a first information processing apparatus comprising second circuitry configured to:
receive the first authentication information of the user from the information terminal;
perform authentication of the user based on the first authentication information; and
based on a determination that authentication of the user is successful, transmit, to the information terminal, the second authentication information associated with the first authentication information.

6. The information processing system of claim 5, further comprising:
a second information processing apparatus including third circuitry configured to
receive, from the information terminal, the second authentication information of the user, the second authentication information being transmitted from the first information processing apparatus based on successful authentication of the user;
perform authentication of the user based on the second authentication information of the user; and
provide a service corresponding to the user to the information terminal based on a determination that the authentication of the user is successful.

7. An information processing apparatus comprising circuitry,
the circuitry being configured to:
receive, from an information terminal, first authentication information of a user read from a medium possessed by the user;
perform authentication of the user based on the first authentication information; and
based on a determination that authentication of the user is successful, transmit, to the information terminal, second authentication information associated with the first authentication information, the second authentication information to be used for allowing the user to log in to other information processing apparatus, the other information processing apparatus residing on a network different from a network where the information processing apparatus resides and providing to the information terminal a service corresponding to the user.

8. An information processing apparatus comprising circuitry,
the circuitry being configured to:
receive, from an information terminal, authentication information of a user;
determine whether the authentication information of the user is second authentication information associated with first authentication information, which is transmitted from other information processing apparatus that has authenticated the user at the information terminal using the first authentication information;
perform authentication of the user based on the authentication information of the user, based on a determination that the authentication information of the user is second authentication information; and
provide a service corresponding to the user to the information terminal based on a determination that the authentication of the user is successful.

9. An information processing method performed by an information terminal, the method comprising:
reading, from a medium possessed by a user, first authentication information of the user;
transmitting an authentication request including the first authentication information of the user read in the reading to a first information processing apparatus that manages information regarding the user;
receiving, from the first information processing apparatus in response to the authentication request, second authentication information associated with the first authentication information, the second authentication information to be used for allowing the user to log in to a second information processing apparatus that resides on a network different from a network where the first information processing apparatus resides; and
transmitting the second authentication information received in the receiving to the second information processing apparatus to request the second information processing apparatus for a service corresponding to the user.

10. The method of claim 9, further comprising:
transmitting identification information of the information terminal to the second information processing apparatus to request for device authentication of the information terminal, before transmitting the second authentication information to the second information processing apparatus.
